(19) United States
(12) Patent Application Publication
(10) Pub. No.: US 2015/0077648 A1
(43) Pub. Date: Mar. 19, 2015

(54) TOUCH PANEL

(71) Applicant: SILITECH TECHNOLOGY CORP., New Taipei City (TW)

(72) Inventors: Yui-Chen Huang, Taipei City (TW); Yu-Chieh Lin, New Taipei City (TW); Jyun-Ci Chen, New Taipei City (TW); Jie-Shiang Hu, New Taipei City (TW)

(73) Assignee: SILITECH TECHNOLOGY CORP., New Taipei City (TW)

(21) Appl. No.: 14/065,430

(22) Filed: Oct. 29, 2013

(30) Foreign Application Priority Data
Sep. 18, 2013 (TW) 102133954

(51) Int. Cl. G06F 3/041

(52) U.S. Cl. CPC G06F 3/041
USPC 349/12

(57) ABSTRACT

A touch panel includes a substrate, a decoration pattern, a covering layer, and a touch sensing element. The substrate has a first region and a second region. The decoration pattern is disposed on the first region of the substrate and has a first thickness. The covering layer includes a first portion covering the second region of the substrate and a second portion covering the decoration pattern, wherein the second portion has a second thickness and the first portion has a third thickness. The second thickness is less than the third thickness. The touch sensing element is disposed on the covering layer.

### CROSS-REFERENCE TO RELATED APPLICATION

This application claims the priority benefit of Taiwan application Ser. No. 102133954, filed on Sep. 18, 2013. The entirety of the above-mentioned patent application is hereby incorporated by reference herein and made a part of this specification.

### BACKGROUND OF THE INVENTION

1. [Field of the Invention]

The invention relates to a touch panel and particularly relates to a touch panel with a decoration pattern.

2. [Description of Related Art]

With the rapid development of electronic technology, many information products have changed their input devices from traditional keyboards or mice to touch apparatuses. Therefore, touch panels have been widely used. Currently, the development of many mobile electronic products trends to the use of touch display panels, that is, technology of integrating the touch panel with the display panel.

Generally speaking, multiple wires are disposed at the periphery of the touch panel to transmit sensing signals generated from the user's operations of the touch panel. To keep the wires from being seen by the user, a decoration pattern is usually disposed on the touch panel at a position corresponding to the layout of the wires for covering the wires and embellishing the appearance of the touch panel.

The decoration pattern has a specific thickness. Thus, when disposing the decoration pattern on the substrate of the touch panel, the decoration pattern protrudes from the substrate surface to form a height difference. Such a height difference may easily cause disconnection of the wires in the subsequent fabricating processes of the touch sensing element, which results in low yield rate. In addition, the height difference also causes difficulty in bonding other films or layers to the substrate.

### SUMMARY OF THE INVENTION

The invention provides a touch panel formed with a covering layer for disposing a touch sensing element on a flattened surface, and thus has a favorable fabrication yield rate.

The invention provides a touch panel that includes a substrate, a decoration pattern, a covering layer, and a touch sensing element. The substrate has a first region and a second region. The decoration pattern is disposed on the first region of the substrate and has a first thickness. The covering layer includes a first portion that covers the second region of the substrate and a second portion that covers the decoration pattern. The second portion has a second thickness. The first portion has a third thickness. The second thickness is less than the third thickness. The touch sensing element is disposed on the covering layer and the decoration pattern.

In an embodiment of the invention, the third thickness is equal to a total of the first thickness and the second thickness.

In an embodiment of the invention, a material of the covering layer includes an insulating material.

In an embodiment of the invention, the insulating material includes a thermosetting resin or a UV-curable resin.

In an embodiment of the invention, the touch panel further includes an adhesive layer. The adhesive layer is adhered between the covering layer and the touch sensing element, wherein the touch sensing element includes a base and a touch sensing electrode layer, and the base is disposed between the adhesive layer and the touch sensing electrode layer.

In an embodiment of the invention, the touch sensing element includes a touch sensing electrode layer disposed directly on the covering layer.

Based on the above, according to the invention, the covering layer is disposed to moderate the effect caused by the height difference between the decoration pattern and the substrate. The covering layer moderates the height difference at the substrate surface to form a flattened surface, which facilitates fabrication and configuration of the touch sensing element and improves the fabrication yield rate of the touch panel.

To make the aforementioned and other features and advantages of the invention more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1 is a cross-sectional view of a touch panel according to an embodiment of the invention.

FIG. 2 is a cross-sectional view of a touch panel according to another embodiment of the invention.

FIG. 3 is a cross-sectional view of a touch panel according to further another embodiment of the invention.

FIG. 4 is a cross-sectional view of a touch panel according to still another embodiment of the invention.

### DESCRIPTION OF THE EMBODIMENTS

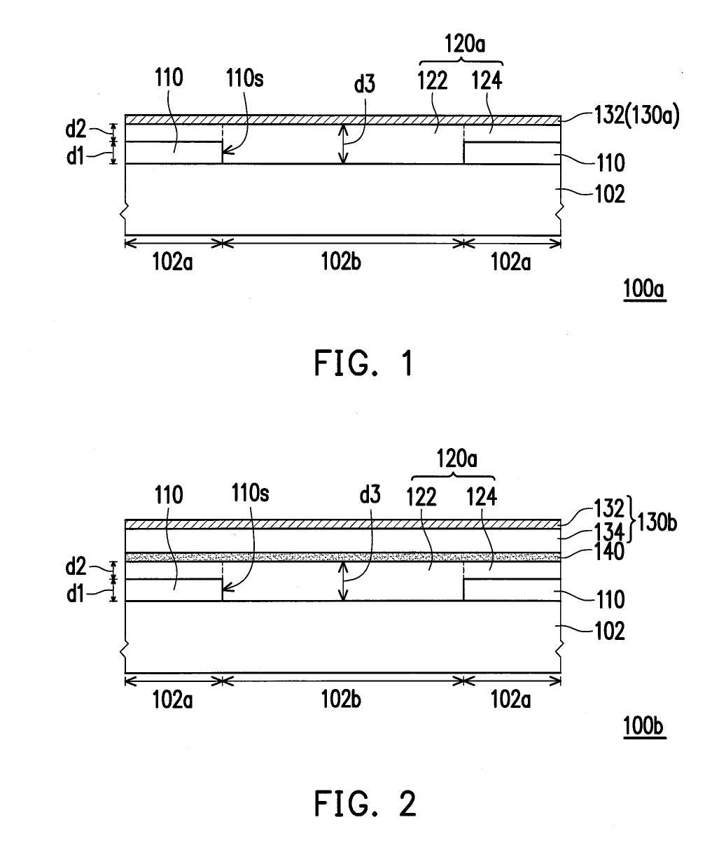

FIG. 1 is a cross-sectional view of a touch panel according to an embodiment of the invention. With reference to FIG. 1, a touch panel 100a includes a substrate 102, a decoration pattern 110, a covering layer 120a, and a touch sensing element 130a. The substrate 102 has a first region 102a and a second region 102b. Here, the first region 102a and the second region 102b are two regions adjacent to each other. The first region 102a can be deemed as a region disposed at a periphery of the second region 102b. That is, the first region 102a can surround the second region 102b. Therefore, FIG. 1 illustrates that the first region 102a is disposed at two opposite sides of the second region 102b; however, it should be noted that the invention is not limited thereto.

In some other embodiments, the first region 102a may be disposed at only one side of the second region 102b.

The decoration pattern 110 is disposed on the first region 102a of the substrate 102 and has a first thickness d1. The decoration pattern 110 is disposed for decoration, so as to generate a desired visual effect. That is to say, a region where the decoration pattern 110 is located is a non-translucent region of the touch panel 100a, for example. Because the decoration pattern 110 has a function of shielding/blocking light, peripheral wirings of the touch panel 100a or components that should not be seen by the user may be disposed in the region where the decoration pattern 110 is located. Accordingly, the decoration pattern 110 can cover the peripheral wirings and partial components disposed in the first region 102a when the substrate 102 is located between the users and the decoration pattern 110 to provide a favorable appearance.

Furthermore, the decoration pattern 110 may have a specific design, so that the decoration pattern 110 can not only provide the shielding function but also embellish the appearance of the touch panel 100. The decoration pattern 110 is an organic photoresist layer, an ink layer, or other suitable decoration material layers, for example. For instance, the decoration pattern 110 may be a white resin layer, a black resin layer, or other colored resin layers. Or, the decoration pattern 110 may be a black ink layer, a white ink layer, or other colored ink layers. Or, the decoration pattern 110 may be formed using other materials having light-shielding properties, such as a metal material.

The covering layer 120a includes a first portion 122 and a second portion 124, and the second portion 124 covers a side surface 110s of the decoration pattern 110. In other words, the covering layer 120a is a layered material that continuously extends from the second region 102b to the first region 102a. The first portion 122 covers the second region 102b of the substrate 102 and has a third thickness d3. The second portion 124 covers the decoration pattern 110 and has a second thickness d2. The second thickness d2 is less than the third thickness d3. In other words, the first portion 122 that covers the second region 102b of the substrate 102 is thicker, and the second portion 124 that covers the decoration pattern 110 is thinner. In an exemplary embodiment, a total of the first thickness d1 of the decoration pattern 110 and the second thickness d2 of the first portion 122 is equal to the third thickness d3 of the second portion 124. Therefore, the covering layer 120a has a flattened surface. In other words, a protruding structure resulting from disposing the decoration pattern 110 on the substrate 102 is covered by the covering layer 120a after the covering layer 120a with the second thickness d2 and the third thickness d3 is fabricated, and therefore, the flattened surface is obtained.

For example, a material of the covering layer 120a is an insulating material, such as a thermosetting resin or a UV-curable resin. In an exemplary embodiment, preferably the covering layer 120a is formed using a high-transmittance material. In this embodiment, the covering layer 120a may be formed by a lamination process. Thus, the covering layer 120a has further thinner thickness when comparing to the thickness of the covering layer formed using another process such as a coating process.

The touch sensing element 130a is disposed on the covering layer 120a. The touch sensing element 130a includes a touch sensing electrode layer 132. The touch sensing electrode layer 132 is disposed directly on the covering layer 120a, for example. Because the covering layer 120a facilitates the device having the flattened surface, when the touch sensing element 130a is directly formed on the covering layer 120a, problems, such as disconnection of wires, do not occur on the touch sensing electrode layer 132 easily, and therefore the fabrication yield rate is favorable. That is to say, the touch panel 100a of this embodiment has favorable fabrication yield rate and processability. Therefore, problems, such as defective fabrication of the touch sensing element 130a resulting from a height difference at boundaries of the decoration pattern 110, do not easily occur. In addition, this disclosure is not intended to limit a sensing type of the touch sensing element 130a of the invention, which may be a mutual-capacitive touch sensing element or a self-capacitive touch sensing element. The touch sensing electrode layer 132 may be formed using a transparent conductive material; however, it should be noted that the invention is not limited thereto. In some other embodiments, the touch sensing electrode layer 132 may be formed using a metal grid or a touch electrode structure of other forms.

In addition, the touch panel 100a may be a component substrate of a display or a substrate independent of a display. For instance, the touch panel 100a may be a color filter substrate or an active device array substrate integrated with a touch function, or the touch panel 100a may be a cover lens integrated with a touch function that is disposed on an independent display panel; however, it should be noted that the invention is not limited thereto.

FIG. 2 is a cross-sectional view of a touch panel according to another embodiment of the invention. A touch panel 100b of FIG. 2 is similar to the touch panel 100a of FIG. 1. Therefore, in the embodiment of FIG. 2, the same reference numerals are used to refer to identical components, and technical contents thereof can be found in the descriptions of the above embodiments. A difference therebetween is explained below.

With reference to FIG. 2, a touch sensing element 130b of the touch panel 100b is for example adhered onto the covering layer 120a via an adhesive layer 140. That is, the adhesive layer 140 is adhered between the covering layer 120a and the touch sensing element 130b. More specifically, the touch sensing element 130b includes a touch sensing electrode layer 132 and a base 134, wherein the base 134 is disposed between the adhesive layer 140 and the touch sensing electrode layer 132. The base 134 includes a glass or a thin film substrate. In this embodiment, the base 134 is a thin film substrate, and a material thereof is polyethylene terephthalate (PET), for example. In other words, a method of fabricating the touch panel 100b includes: first, fabricating the touch sensing electrode layer 132 on the base 134 to form the touch sensing element 130b; and then adhering the touch sensing element 130b onto the covering layer 120a via the adhesive layer 140.

In this embodiment, because the covering layer 120a facilitates the device to have the flattened surface, the thickness of the adhesive layer 140 coated on the covering layer 120a does not require to compensate the height difference and can be very thin. Therefore, the overall thickness of the touch panel 100b is not increased significantly by the adhesive layer 140. Furthermore, if the decoration pattern 110 is a bright-colored decoration pattern (e.g. white), the decoration pattern 110 needs to be thicker to provide a sufficient optical density so as to shield the peripheral wirings. In such a case, the conventional technique requires use of a thicker adhesive layer to compensate the height difference between the decoration pattern 110 and the substrate 102, so as to adhere the touch sensing element 130b, and the thickness thereof is 150 μm, for example. By contrast, the touch panel 100b of this embodiment is provided with the covering layer 120a. Thus, the thickness of the adhesive layer 140 can be reduced to about 50 μm, which helps to reduce the overall thickness of the touch panel 100b.

Moreover, when the thin film substrate 134 of the touch sensing element 130b is adhered to the covering layer 120a, the adhering surfaces are flattened. Consequently, bubbles do not occur easily at the adhering interface, and the thin film substrate 134 does not bend for conforming to the height difference. Accordingly, the touch panel 100b is good in fabrication yield rate.

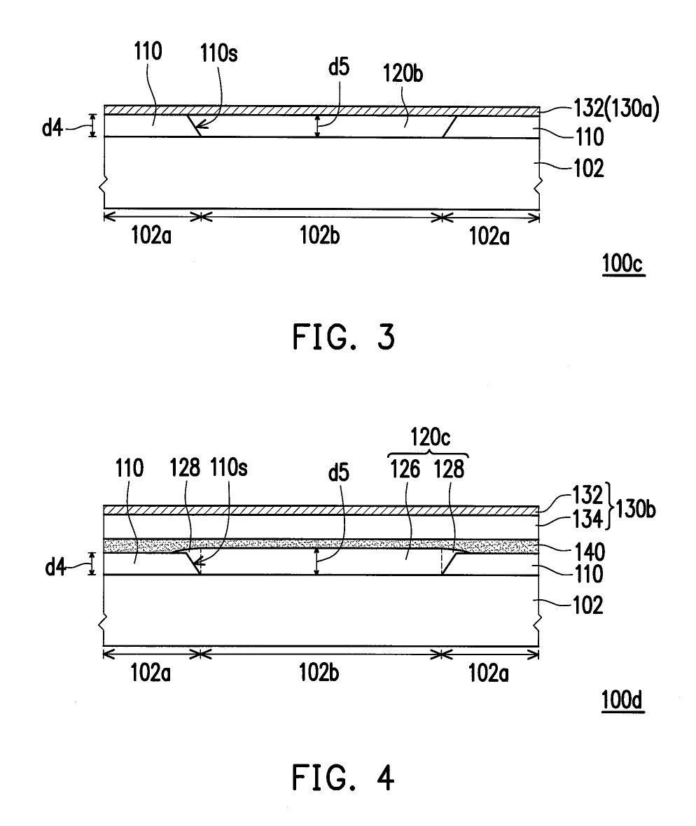

FIG. 3 is a cross-sectional view of a touch panel according to another embodiment of the invention. A touch panel 100c of FIG. 3 is similar to the touch panel 100a of FIG. 1. Therefore, in the embodiment of FIG. 3, the same reference numerals are used to refer to identical components, and technical contents thereof can be found in the descriptions of the above embodiments. A difference therebetween is explained below.

With reference to FIG. 3, a substrate 102 of the touch panel 100c has a first region 102a and a second region 102b. The decoration pattern 110 is disposed on the first region 102a and has a fourth thickness d4. The decoration pattern 110 has a side surface 110s, for example. Descriptions regarding the material of the decoration pattern 110 can be found in the above embodiments and thus will not be repeated hereinafter.

The covering layer 120b covers the second region 102b of the substrate 102 and has a fifth thickness d5. The covering layer 120b covers the side surface 110s of the decoration pattern 110, wherein the fifth thickness d5 is not less than the fourth thickness d4. In this embodiment, the fifth thickness d5 is approximately equal to the fourth thickness d4. Therefore, the covering layer 120b and the decoration pattern 110 have the same thickness, and top surfaces thereof are substantially flush with each other. In other words, the top surfaces of the covering layer 120b and the decoration pattern 110 together form a flattened surface. Regarding the material of the covering layer 120b, please refer to the descriptions of the covering layer 120a in the above embodiments, which will not be repeated hereinafter.

In this embodiment, the touch sensing element 130a is disposed on the covering layer 120b and the decoration pattern 110. Because the covering layer 120b and the decoration pattern 110 form the flattened surface, problems, such as disconnection of wires or improper adhesion, do not easily occur during the fabrication of the touch sensing electrode layer 132 of the touch sensing element 130a. Thus, the touch panel 100d has a good fabrication yield rate.

FIG. 4 is a cross-sectional view of a touch panel according to another embodiment of the invention. A touch panel 100d of FIG. 4 is similar to the touch panel 100b of FIG. 2. Therefore, in the embodiment of FIG. 4, the same reference numerals are used to refer to identical components, and technical contents thereof can be found in the descriptions of the above embodiments. A difference therebetween is explained below.

With reference to FIG. 4, the substrate 102 of the touch panel 100d includes a first region 102a and a second region 102b. The decoration pattern 110 is disposed on the first region 102a and has a fourth thickness d4. The decoration pattern 110 has a side surface 110s, for example. Descriptions regarding the material of the decoration pattern 110 can be found in the above embodiments and thus will not be repeated hereinafter.

In this embodiment, a covering layer 120c has a main body portion 126 and an extension portion 128. The main body portion 126 covers the second region 102b of the substrate 102 and has a fifth thickness d5. The main body portion 126 extends from the second region 102b toward the first region 102a, such that the extension portion 128 covers the side surface 110s of the decoration pattern 110, wherein the fifth thickness d5 is not less than the fourth thickness d4. In this embodiment, the fifth thickness d5 is slightly greater than the fourth thickness d4. Moreover, the extension portion 128 extends from the main body portion 126 toward the decoration pattern 110, and a thickness thereof gradually decreases so that the extension portion 128 has a tapered edge. In other words, the extension portion 128 covers a partial region of the top surface of the decoration pattern 110.

In this embodiment, the main body portion 126 has a flattened top surface while the extension portion 128 has the tapered edge with gradually decreasing thickness. Therefore, there is no obvious height difference between the main body portion 126 and the decoration pattern 110. When the touch sensing element 130b is disposed on the covering layer 120c and the decoration pattern 110, problems, such as disconnection of wires, do not easily occur during the fabrication of the touch sensing electrode layer 132 of the touch sensing element 130a. Thus, the touch panel 100d has good fabrication yield rate.

To conclude the above, in the invention, the covering layer is disposed to reduce the height difference between the decoration pattern and the substrate. Moreover, the covering layer has the flattened surface to facilitate fabrication of the touch sensing element and prevent the problem of disconnection of wires. In addition, when the touch sensing element is adhered to the covering layer by an adhering method, generation of bubbles is reduced. Accordingly, the fabrication yield rate of the touch panel is significantly improved.

What is claimed is:

1. A touch panel, comprising:
a substrate comprising a first region and a second region;
a decoration pattern disposed on the first region of the substrate and having a first thickness;
a covering layer comprising a first portion that covers the second region of the substrate and a second portion that covers the decoration pattern, wherein the second portion has a second thickness and the first portion has a third thickness, and the second thickness is less than the third thickness; and
a touch sensing element disposed on the covering layer.

2. The touch panel according to claim 1, wherein the third thickness is equal to a total of the first thickness and the second thickness.

3. The touch panel according to claim 1, wherein a material of the covering layer comprises an insulating material.

4. The touch panel according to claim 3, wherein the insulating material comprises a thermosetting resin or a UV-curable resin.

5. The touch panel according to claim 1, further comprising an adhesive layer adhered between the covering layer and the touch sensing element, wherein the touch sensing element comprises a base and a touch sensing electrode layer, and the base is disposed between the adhesive layer and the touch sensing electrode layer.

6. The touch panel according to claim 1, wherein the touch sensing element comprises a touch sensing electrode layer disposed directly on the covering layer.
